(19) United States
(12) Patent Application Publication
(10) Pub. No.: US 2023/0219261 A1
(43) Pub. Date: Jul. 13, 2023

(54) A PROCESS FOR RECYCLING A LAMINATE AND A SOLUTION THEREFOR

(71) Applicant: The University of Sydney, Sydney (AU)

(72) Inventors: Brian Stanley HAWKETT, Sydney (AU); Duc Ngoc NGUYEN, Sydney (AU); The Vien HUYNH, Sydney (AU); Pramith PRIYANANDA, Sydney (AU)

(21) Appl. No.: 17/928,247

(22) PCT Filed: May 28, 2021
(86) PCT No.: PCT/AU2021/050523

§ 371 Date: Nov. 28, 2022

(30) Foreign Application Priority Data
May 29, 2020 (AU) 2020901775

(51) Int. Cl. B29B 17/04; B08B 7/02; B08B 3/08; B08B 7/04; B08B 5/02; B08B 5/04; C11D 1/72; C11D 1/29; C11D 1/12; C11D 1/00; C11D 3/04; C11D 3/43; C11D 11/00; B32B 43/00; B29B 17/02

(52) U.S. Cl. CPC B29B 17/0412; B08B 7/02; B08B 3/08; B08B 7/04; B08B 5/02; B08B 5/04; C11D 1/72; C11D 1/29; C11D 1/123; C11D 1/008; C11D 3/044; C11D 3/43; C11D 11/0035; B32B 43/006; B29B 17/02; B08B 2220/01; B29B 2017/0289; B29B 2017/0203; B29B 2017/0021

(57) ABSTRACT

The present invention relates to a recycling process for a laminate and a solution used in such a process. The present invention finds particular application in the removal of an adhered overlay from an underlying substrate material such as plastic. The process includes subjecting the laminate to an impact frictional striking force, thereby substantially separating the substrate layer from the one or more surface layers of the overlay and then washing the substrate layer with a washing solution to remove the remaining surface layers of the overlay and glue from the substrate layer. The washing solution may be an aqueous solution including a surfactant, a solvent and a base.

### CROSS-REFERENCE TO RELATED APPLICATION

This application claims priority to Australian patent application no. 2020901775 (filed on 29 May 2020), the entire contents of which is incorporated herein by reference.

### FIELD OF THE INVENTION

The present invention relates to a recycling process for a laminate and a solution used in such a process. The present invention finds particular application in the removal of an adhered overlay from an underlying substrate material.

### BACKGROUND OF THE INVENTION

Collection and recycling of used material, such as plastic, paper and cardboard, is becoming increasingly environmentally important. One issue that undermines the efficiency of the recycling process involves the difficulty of removing laminated films, such as labels, from bottles, cartons and the like. These labels generally consist of a plurality of layers made of different materials, and an adhesive layer, e.g. glue, that is used to adhere the laminated film to an underlying substrate material.

In order to improve the quality of the recycled material, the labels need to be removed from the substrate material so that the recycling process can be completed with substantially only the substrate material remaining. A known process for recycling plastic labelled bottles involves shredding the plastic material into flake using sharp cutting elements in the presence of a detergent to dissolve the glue adhering the labels to the plastic. The flake may then be further processed using a pin mill to remove fragments of the label from the plastic fragments.

One issue with the known recycling process is that the surface of the plastic fragments may still include the label. This means that the recycled plastic will include impurities that limit the quality of the recycled plastic and to what end-use the recycled plastic may be used. Another issue with the known recycling process is that the surface of the plastic fragments may still include traces of the adhesive used to adhere the laminated film to the plastic. The adhesive can degrade the recycled plastic material if it is not sufficiently removed during the recycling process. Further, the adhesive often adheres to the stationary components of the machinery used during the recycling process. Such contamination necessitates regular cleaning and maintenance of the machinery.

It is desirable to provide a recycling process that alleviates at least one of the known issues mentioned above. Alternatively, it is desirable to provide a recycling process that is a useful alternative to that which is known in the art.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect, the present invention provides a process for recycling a laminate that includes a substrate layer and an overlay adhered to the substrate layer with a glue, the overlay including one or more surface layers, the process including:

subjecting the laminate to an impact frictional striking force, thereby substantially separating the substrate layer from the one or more surface layers of the overlay; and then

washing the substrate layer with a washing solution to remove the remaining surface layers of the overlay from the substrate layer.

Advantageously, the present invention exploits the phenomenon of impact delamination in order to substantially separate a substrate layer of the laminate from the one or more surface layers of the overlay. Delamination is typically caused by matrix cracking, bending cracks, and/or shear cracks experienced by the laminate upon impact. Due to the different rheological properties of the substrate layer and the overlay, when the laminate is subjected to suitable impact forces, these layers of the laminate will produce relatively different responses to the impact force. This difference in response causes delamination between the substrate layer and the overlay.

As the substrate layer and the overlay are generally formed of different materials, the efficiency of the recycling process can be enhanced by separating and separately processing the substrate layer material (and the overlay material if desired).

A further advantage arises from the use of the washing solution. This ensures substantially complete separation of the substrate layer from any remaining surfaces of the overlay and glue in order to allow for improved recycling of the substrate layer. The washing solution also advantageously may assist remove other hydrophilic and/or hydrophobic impurities (ie other than the adhesive or glue) present in the laminate, e.g. on the surface of the substrate layer, embedded within the adhesive or glue and/or in one or more overlay layers.

As one of the main contaminants in a recycling process can be the glue used to adhere the overlay to the substrate layer, the present embodiment provides a solution that assists in removing the glue from the substrate layer during the recycling process. Thus, at the conclusion of the washing step, the substrate layer is substantially free of the glue, making it more suitable for further processing during the recycling process.

The present invention particularly lends itself to recycling processes intended to produce high quality recycled material, such as recycled material for food grade applications.

Depending on where the washing solution is brought into contact with the impacted laminate, the solution may also assist in removing the glue from any equipment used during the recycling process. This can reduce or eliminate periods of downtime in the recycling process that would otherwise be required at regular intervals to clean the equipment. This cleaning of the equipment may be a direct consequence of the washing step.

In an embodiment, the impact frictional striking force is maintained through at least a part of the washing step. In other words, the laminate must undergo at least partial impact delamination due to application of the impact frictional striking force prior to beginning the washing step. However, it is preferred that the step of subjecting the laminate to the impact frictional striking force is stopped before commencement of the washing step. Preferably, a substantial amount of the label and glue is removed before the commencement of the washing step in order to reduce the spread of the glue that may subsequently occur.

In an embodiment, the recycling process further includes fragmenting the laminate, thereby producing laminate fragments. Fragmenting of the laminate can be achieved by any means known in the art. For example, the laminate may be fragmented by milling, shredding, cutting, etc. The fragmenting step may be undertaken before the step of subjecting the laminate to the impact frictional force. However, it is preferred that the fragmenting step is a consequence of the step of subjecting the laminate to the impact frictional force. In other words, the impact frictional force may both fragment the laminate, thereby producing laminate fragments, and substantially separate the substrate layer from the one or more surface layers of the overlay. In such embodiments, the process may comprise a combined fragmenting (or shredding) and impact delaminating step.

In an embodiment, after the subjecting step, but before the washing step, the recycling process further includes segregating a mixture of the separated substrate layer and one or more surface layers of the overlay. The segregating step may include removing the one or more surface layers of the overlay by applying suction or blowing to the mixture. For example, an airstream may be applied to blow the mixture, thereby causing the less compact materials, for example, the one or more surface layers of the overlay, to be removed from the relatively more compact substrate layer. Typically, the airstream may comprise compressed air, or in some embodiments it may comprise nitrogen or air that has been enriched in nitrogen.

In an embodiment, after the subjecting step, but before the washing step, the recycling process further includes filtering a mixture of the separated substrate layer and the one or more surfaces of the overlay in order to remove one or more layers of the overlay from the mixture. In such an embodiment, the filtering step may be followed by the washing step.

In one embodiment, the subjecting step is conducted in dry conditions. In other words, the subjecting step is conducted substantially absent of the presence of a liquid.

In another embodiment, the subjecting step is conducted in wet conditions. In other words, the subjecting step is conducted in the presence of a liquid, wherein the glue is preferably substantially insoluble in the liquid. For example, the liquid may be water. It has been found that when the subjecting step is conducted in the presence of water, the glue remains on the removed overlay, thereby leaving the substrate and any equipment used during the recycling process relatively clean.

In another embodiment, when the subjecting step is conducted in wet conditions, the recycling process further includes drying the mixture of the separated substrate layer and the one or more surfaces of the overlay, preferably before conducting the segregating step.

In one embodiment, the impact frictional striking force is imparted on the laminate by one or more impactors. The one or more impactors are preferably relatively blunt or dull, thereby capable of imparting the requisite impact frictional striking force to substantially separate the substrate layer from the one or more surface layers of the overlay. In an embodiment, the impactors may still be sufficiently sharp in order to fragment the laminate during the step of subjecting the laminate to the impact frictional force. The impactor may comprise an apex, which is typically located on a leading edge that would come into contact with the laminate when in use. The apex may be formed into any appropriate shape, including substantially circular, elliptical, triangular or the like.

The Brubacher Edge Sharpness Scale (BESS) provides a sharpness score calculated for circular shaped blade edges. In some embodiments, the impactor may have a sharpness that is substantially equivalent to a minimum BESS score of about 10,000, 25,000, 50,000, 75,000, 80,000, 90,000, 100,000 or 115,000. The impactor may have a sharpness substantially equivalent to a maximum BESS score of not more than about 1,000,000, 750,000, 500,000, 250,000, 200,000, 150,000, 125,000 or 115,000. The sharpness of the impactor may be from any of these minimum scores to any of these maximum scores provided the minimum score is less than the maximum. For example, the impactor may have a sharpness substantially equivalent to a BESS score from about 10,000 to about 1,000,000 or about 80,000 to about 200,000. In some embodiments, the impactor may have a sharpness substantially equivalent to a BESS score of about 115,000. An impactor with a sharpness substantially equivalent to any of these BESS scores may have any appropriately shaped apex, however its sharpness would be substantially the same as an impactor with a circular apex having the relevant BESS score.

Other factors may influence the force imparted by the impactors on the laminate during the subjecting step. This can include impactor mass, impactor shape, impact energy, the peripheral speed of the impactor. In some embodiments, the one or more impactors form part of a rotor. In such a case, the rotational speed of the impactors will influence the force imparted by the impactors on the laminate during the subjecting step. The impactor preferably includes a blunt leading edge. The impactor may be in the form of a suitably shaped blade. In some embodiments, the blade may have a blade edge with a thickness of at least about 150 μm, 175 μm, 200 μm or more.

In one embodiment, the recycling process further includes drying the washed substrate layer.

In an embodiment, the substrate layer includes a high-density polyethylene (HDPE) material. However, other substrate layers may also be used. For example, the substrate layer may include polyethylene terephthalate (PETE), low-density polyethylene (LDPE), polypropylene (PP), polystyrene (PS), polyethylene (PET), paper, metallic foil (e.g. aluminium foil), a vinyl (eg polyvinylchloride (PVC)), etc., and combinations thereof. In some embodiments, the substrate layer includes PETE, HDPE or a combination thereof.

The one or more surfaces of the overlay may together form a label. The surface layers of the overlay may include one or more of a hot melt pressure sensitive adhesive, a protective clear polyolefin, flexographic ink (e.g. printing ink), laminating adhesive, and protective clear polyolefin.

In some embodiments, the washing solution is an aqueous solution comprising a surfactant and a solvent. Further, the washing solution may further comprise a base and may be preferred when the laminate comprises a crosslinked glue.

Surprisingly, superior overlay and adhesive removal from the substrate layer was achieved when using the washing solution comprising the surfactant and the solvent, compared with conventional techniques. It is believed that inclusion of the solvent may allow lower volumes of solution to be employed in some embodiments as the solution is better able to separate the adhesive from the substrate following at least partial impact delamination. This washing solution can be employed in a conventional wet process, or may be combined with the impact delamination steps described herein. Thus, the washing step with the solution of the invention may be advantageous to recycling processes when recycled materials of higher purity are desired.

In an embodiment, the laminate may include further layers adhered or bonded to the overlay and/or substrate. For example, layers of the laminate in addition to the overlay may need to be removed to expose the substrate. However, in an embodiment these additional layers may be removed as part of the subjecting step.

In one embodiment, there is provided a process for recycling a laminate that includes a substrate layer and an overlay adhered to the substrate layer with a glue, the overlay including one or more surface layers, the process including: subjecting the laminate to an impact frictional striking force, thereby substantially separating the substrate layer from the one or more surface layers of the overlay, wherein the subjecting is conducted in dry conditions; segregating the substrate layer from the removed one or more surface layers of the overlay; washing the substrate layer with a washing solution to remove the remaining surface layers of the overlay from the substrate layer; rinsing the substrate layer; and drying the substrate layer.

In one embodiment, there is provided a process for recycling a laminate that includes a substrate layer and an overlay adhered to the substrate layer with a glue, the overlay including one or more surface layers, the process including: subjecting the laminate to an impact frictional striking force, thereby substantially separating the substrate layer from the one or more surface layers of the overlay, wherein the subjecting is conducted in wet conditions; drying a mixture of the substrate layer and removed one or more surface layers; segregating the substrate layer from the removed one or more surface layers of the overlay; washing the substrate layer with a washing solution to remove the remaining surface layers of the overlay from the substrate layer; rinsing the substrate layer; and drying the substrate layer.

In an embodiment, after the washing step, the process further includes recovering at least a portion of the washing solution. The recovering step may comprise separating a used washing solution into separate liquid phases. Thus separating the used washing solution may form a waste layer and a liquid layer comprising washing solution. In some embodiments, separating the waste layer and the washing solution layer may be achieved by heating the used washing solution. Upon removal of the waste layer, the remaining washing solution can be re-used for subsequent washing steps. The waste layer may include glue and other contaminants. The heating step may involve heating to a temperature below the boiling point of the used washing solution but above the cloud point of the surfactant and/or polymeric dispersing agent used therein. In some embodiments, the used washing solution is heated to a temperature of about 95° C. or higher.

In a second aspect, the present invention provides a process for recycling a laminate that includes a substrate layer and an overlay adhered to the substrate layer, the overlay including one or more surface layers, the process including:

washing the substrate layer with a washing solution to remove the one or more surface layers of the overlay from the substrate layer, the solution comprising a surfactant and a solvent. The solution used in this aspect may be any of the washing solutions described herein.

In an embodiment, the process may include the step of subjecting the laminate to an impact frictional striking force, thereby substantially separating the substrate layer from the one or more surface layers of the overlay.

Any of the features described above in connection with the first aspect of the invention may have application to the second aspect of the invention.

In a third aspect, the present invention provides a process for recycling a laminate that includes a substrate layer and an overlay adhered to the substrate layer with a glue, the overlay including one or more surface layers, the process including:

subjecting the laminate to an impact frictional striking force, thereby substantially separating the substrate layer from the one or more surfaces of the overlay, wherein the subjecting step also fragments the laminate.

Any of the features described above in connection with the first or second aspect of the invention may have application to the third aspect of the invention.

In a fourth aspect, the present invention provides use of a solution comprising a surfactant and/or a polymeric dispersing agent, and a base for removing a glue from a laminate comprising a substrate and an overlay adhered to the substrate with the glue, the overlay comprising one or more surface layers. In some embodiments, the surfactant and/or polymeric dispersing agent may have a cloud point below the boiling point of the washing solution.

In a fifth aspect, the present invention provides a recycling process, the process including washing a laminate, which includes a substrate layer adhered to an overlay including one or more surface layers, with a washing solution to remove at least one of the one or more surface layers of the overlay from the substrate layer, the washing solution comprising a surfactant and/or polymeric dispersing agent, a solvent and optionally a base, wherein the surfactant and/or polymeric dispersing agent has/have a cloud point that is below a boiling point of the washing solution; and heating the washing solution to above the cloud point of the surfactant and/or polymeric dispersing agent. The recycling process may include subjecting the laminate to an impact frictional striking force such as any appropriate step described herein.

The heating step may occur together with the washing step (eg the washing step and heating step may overlap), or the heating step can be carried out separately, for example after removal of the substrate layer and overlay from the washing solution. In an embodiment, the heating step comprises heating to a temperature of about 95° C. or higher. Any suitable means for heating the used washing solution may be employed. Advantageously, heating the used washing solution assists fractionate the solution into at least a glue-containing phase and a phase comprising substantially regenerated washing solution. The method may also further comprise, after the heating step, recycling a portion of the used washing solution back into a washing step of the process for further use. Typically this recycling step will occur after fractionation and removal of at least a portion of a glue-containing layer.

Any of the features described herein in connection with the first, second or third, fourth or fifth aspect(s) of the invention may have application to any other of the first, second, third, fourth and/or fifth aspect(s) of the invention.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 provides a scanning electron microscopy (SEM) image of a label overlay adhered to a HDPE bottle substrate by a layer of glue;

FIG. 2 is an illustrative diagram of an impact delamination step in accordance with an embodiment of the present invention;

FIG. 3 provides an infrared (IR) spectrum on the glue used to adhere the label overlay to the HDPE bottle substrate;

FIG. 4 provides an IR spectrum on a clean HDPE sample;

FIG. 5 provides an IR spectrum on a HDPE sample following a conventional recycling process;

FIG. 6 provides an SEM image of the surface of a substrate following a conventional recycling process;

FIG. 7 provides an IR spectrum on a HDPE sample obtained after an impact delamination step in accordance with an embodiment of the invention;

FIG. 8 provides an SEM image of a clean HDPE surface substantially free of any of the label or adhesive obtained after an impact delamination step and a washing step in accordance with an embodiment of the invention;

FIG. 9 provides an IR spectrum a clean HDPE surface substantially free of any of the label or adhesive obtained after an impact delamination step and a washing step in accordance with an embodiment of the invention; and

FIG. 10 provides an image of a phase separated washing solution which has been heated after being used in a washing step in accordance with an embodiment of the invention.

### DETAILED DESCRIPTION OF THE EMBODIMENTS

Embodiments of the present invention will be described below. The invention relates to a recycling process for recycling a laminate that includes a substrate layer and an overlay adhered thereto. The overlay includes one or more surface layers.

To provide context, the results of a conventional recycling process will be briefly discussed and ultimately contrasted to a recycling process of the present invention. The following examples relate to a recycling process, whereby the aim is to sufficiently remove or separate the overlay (and any adhesive material) from the substrate, so the substrate material can be recycled. For example, in an embodiment, the process may be used to remove a low density polyethylene (LDPE) label from a high-density polyethylene (HDPE) bottle.

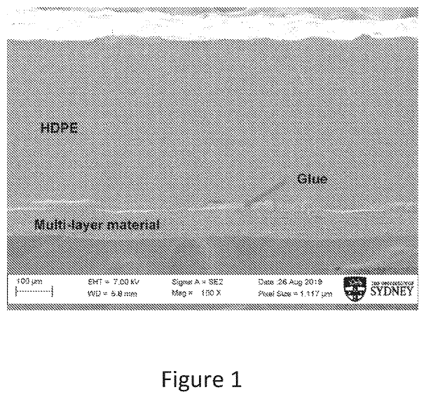

For example, FIG. 1 is an image taken from a microscope showing a conventional HDPE bottle substrate layer having a multilayer label that is adhered to the substrate layer by a hot melt pressure sensitive adhesive. The multilayer label may include a protective clear polyolefin film, printing ink, a laminating adhesive, and protective clear polyolefin.

Under conventionally employed recycling processes, there remains excessive contamination of the HDPE bottle due to the remains of the label and/or adhesive (e.g. glue) on the bottle after processing.

One major difficulty in recycling packaging material is the removal of glue. Glue is used to bind each layer of the laminate together. Optimised processes involve removal of the glue while retaining the maximum amount of the material to be recycled. A scanning electron microscopy (SEM) image of the surface of a substrate following a conventional recycling process is shown in FIG. 6. This image shows that small amounts of glue are retained on the substrate surface following conventional recycling processes. Carrying the adhesive into later stages of recycling can have a significant impact on downstream processes by requiring additional chemical additives, resulting in lower yields of recycled material and/or resulting in increased machinery downtime for cleaning.

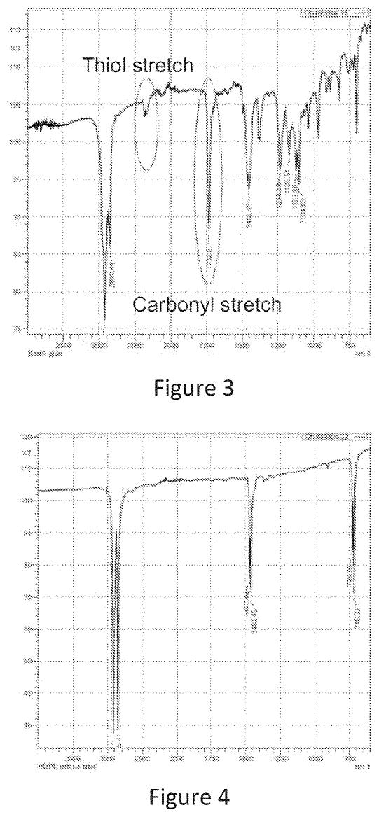

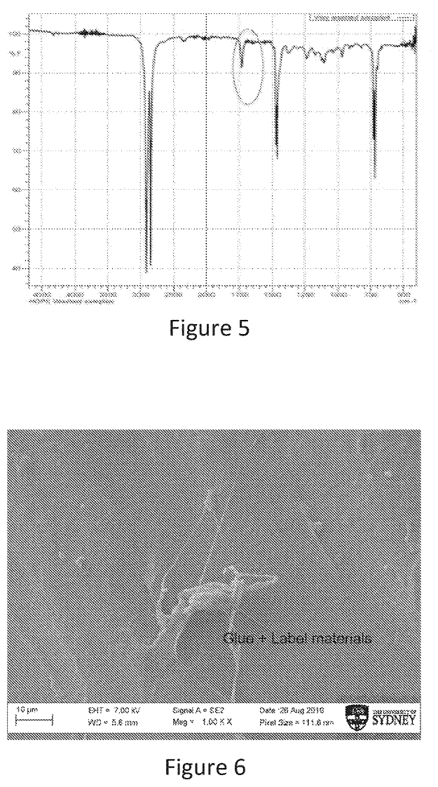

In addition to SEM, the presence of adhesive on the surface of the substrate can be determined by infrared spectroscopy. FIG. 3 is an infrared (IR) spectrum of the glue used to adhere the label to the HDPE bottle, with the circled areas of FIG. 3 denoting the thiol and carbonyl stretches characteristic of the glue. FIG. 4 is an IR spectrum of a clean HDPE sample. FIG. 5 illustrates an IR spectroscopy conducted on a HDPE flake following a conventional process, showing in the circled area of FIG. 5 a carbonyl stretch indicating that some glue remains on the flake surface.

An embodiment of the present invention will now be described. The HDPE laminate, for example a HDPE bottle, is introduced into a processing region of a processing apparatus having one or more impactors for imparting sufficient force to the laminate in order to produce the desired delamination effect between the HDPE substrate and the overlay. In one embodiment, this step may be preceded by a separate step in which the portion(s) of the bottle having the overlay are separated from the remainder of the laminate after the laminate undergoes a fragmenting step. In such a case, the overlay portion may be separately processed from the remainder of the laminate, or processed together with the remainder of the laminate. The fragmenting step may also be used to produce reduced size flake of the HDPE laminate. However, it will be appreciated that steps of separating the portion(s) of the bottle having the overlay from the remainder of the laminate or undertaking the fragmenting step are not necessary. The entire laminate can simply be subjected to the one or more impactors, with the force imparted by the impactors producing both a fragmenting/cutting effect and the desired impact delamination effect.

It will be understood that the meaning of the term “flake” used herein includes use of the term as a collective noun as understood by a person skilled in the art. Thus, the term “flake” may refer to a single flake or to a plurality of flakes.

The following steps will be described from the point of view of the portion(s) of the laminate that have the overlay adhered thereto.

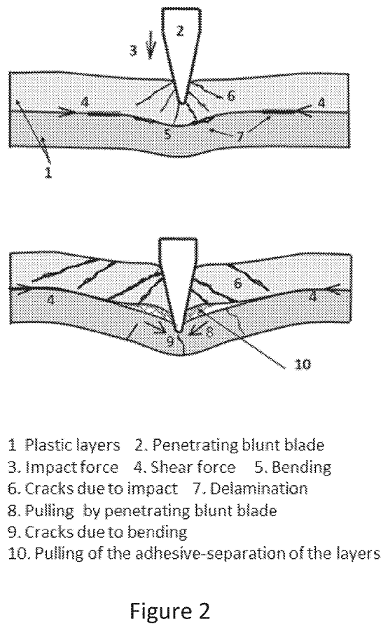

Upon introduction of the laminate into the processing region, the laminate is subjected to impact frictional forces by one or more rotating impactors, e.g. blades, each blade suitably shaped to impart these forces on the laminate. For illustrative purposes, reference is made to FIG. 2 to describe the impact delamination process. The forces on the laminate, depicted as plastic layers 1 (an overlay layer and a substrate layer), are intended to break the laminate into flake (or further flake), and impart the desired delamination effect. In other words, the intention of the blades 2 is to strike or bash the laminate, invariably penetrating and causing fracture and breakage of the laminate. To this end, the blades 2 are suitably shaped to achieve the desired effect. For example, the blades can have a relatively blunt leading edge (as shown in FIG. 2) so that upon contact with the portion(s) of the laminate, the desired impact frictional striking force is imparted. For example, the impact striking force 3, generally shown acting in a direction substantially normal to the laminate, produces shear forces 4 and bending forces 5, resulting in cracks 6 due to the impact, delamination 7, pulling forces 8, cracks 9 due to bending, and ultimately pulling of the adhesive and separation 10 of the overlay and substrate layers.

The blades are to be rotated at a suitable speed in order to impart the requisite force and produce the intended impact delamination. Ultimately, the result of this step is to produce a mixture of HDPE flake that are substantially free of the overlay and the now delaminated pulp label material.

In order to achieve the desired impact delamination, parameters such as rotational speed and/or peripheral speed of the blade, force, strain, temperature, pressure, etc., can be controlled by any means known in the art. Further, one or more sensors may be arranged within or adjacent the processing region, the sensors monitoring one or more of the parameters mentioned above. An operator of the processing apparatus may receive data from the sensors relating to the above mentioned parameters and use this data to make manual adjustments to these parameters in order to improve the impact delamination process. Alternatively, a feedback system may be implemented, whereby the sensor data is sent to a nearby or remote controller, which can utilise this data and adjust parameters to achieve more effective impact delamination.

Another means to control the impact delamination step is through the design of the impactor, i.e. the physical form of the impactor. In this example, the form of the impactors influences the effectiveness of the impact delamination step. For example, the dimensions, mass, and/or shape of the impactors, or inclination/declination of the leading and/or trailing edges of the impactors may be suitably designed in order to produce the desired impact loads. The impactors may be defined by their sharpness, for example using the BESS, which assumes a substantially circular apex as the BESS is based on the edge apex radius. For example, a score of 500 on the BESS means an edge apex radius of 500 nm (or an edge apex width of 1 micron). Thus, the dimensions of an apex of the impactor may be determined based on its BESS, including any of the BESS scores described herein. Preferred impactors, upon impact with the laminate, may provide both the desired impact delamination and fragmentation of the laminate. These parameters mentioned above, in combination with the speed controls mentioned above, can be provided as an input in the feedback system described above and taken into account by the controller when determining whether adjustment in the process is required.

In an embodiment, this step of imparting frictional impact forces to the laminate is conducted in dry conditions, i.e. in the absence of any appreciable solution or other liquid. Conducting this step in dry conditions may result in the glue adhering to the removed overlay material, as well as on the stationary components of any equipment used in the system.

In many cases, the material desired to be retrieved for further processing is the substrate (for example the HDPE flake produced by the impact delamination step above), with the delaminated pulp overlay material being a waste product in this process. In other embodiments, there may be a desire to retrieve and retain the overlay material for later processing.

In another embodiment, the step of imparting frictional impact forces to the laminate is conducted in wet conditions, i.e. in the presence of a liquid. The glue is preferably insoluble in this liquid. This liquid is preferably water. It has been found that when the subjecting step is conducted in the presence of water, the glue remains on the removed overlay, thereby leaving the substrate and any equipment used during the recycling process relatively clean. In this embodiment, the mixture of HDPE flake and overlay material should be first dried before the process moves forward.

In any of the cases described above, the mixture of HDPE flakes and overlay material requires segregation/separation. This can be achieved in any suitable manner known in the art. For example, in order to take advantage of the relative difference in compactness between the HDPE flake and the label material, suitable blowing or suction may be applied, thereby physically separating the less compact label material from the more compact HDPE flake. This step of the process may be conducted in combination with a suitable filtering step. The filtering may be achieved by arranging a suitable screen, configured to permit passage of only certain sized material, between the processing region and an exit path. For example, the screen may permit passage of the pulp label material towards the exit path, but restrict passage of the HDPE flake. Preferably, at the conclusion of this step, there remains substantially only the HDPE flakes in the processing region. Alternatively, the screen may permit passage of the HDPE flake towards the exit path, but restrict passage of the pulp label material, thereby substantially only the pulp label material remains in the processing region. It is noted that the desired result at this stage is that HDPE flake are substantially free of the label material and adhesive. However, it may still be the case that there is some remaining adhesive and/or label material remaining on a small portion of the HDPE flake.

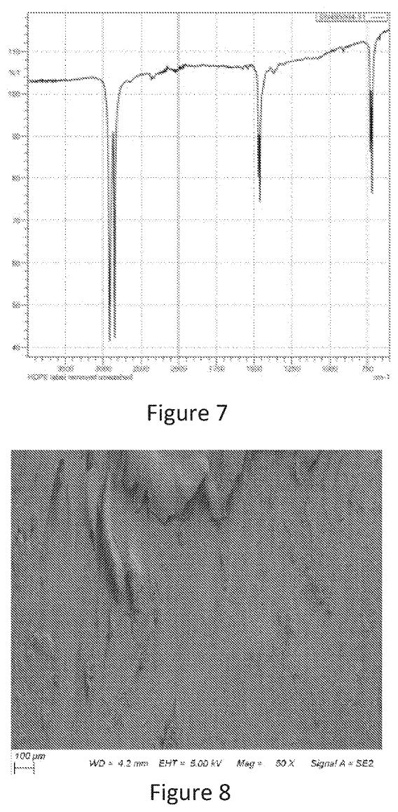

FIG. 7 is an IR spectrum conducted on a HDPE flake obtained by an impact delamination step as described above and in the Examples below. This IR spectrum indicates substantial separation of the substrate and overlay, with low amounts of glue remaining (indicated by the thiol stretch at about 2300 cm⁻¹). Remaining glue may be substantially removed by a washing step.

A washing step may now be performed on the remaining HDPE flake. To this end, a suitable solution, which will be described in greater detail below, is introduced into the processing region and onto the HDPE flake. It will be appreciated that the washing step need not take place in the processing region, but may take place away from the processing region. For example, the HDPE flakes may be transferred to another designated washing region of the apparatus (or to another apparatus entirely). Further, the HDPE flake may be transferred to a pre-prepared solution bath.

Irrespective of the approach taken above, the conclusion of the impact delamination step has been found to leave adhesive material on components in, or adjacent regions of, the processing region where the impact delamination step is performed. Thus, the process may include a separate cleaning step, whereby the processing region is cleaned by introducing the solution into this region. If the HDPE flake are still in the processing region for this, the cleaning step can form part of the overall washing step. Alternatively, the cleaning step may take place separately to the washing of the HDPE flake at any point after the impact delamination step.

In this example, the HDPE flake is transferred to a separate washing region for the washing step of the process. The HDPE flake is introduced into a pre-prepared solution bath in the washing region. Once the HDPE flake is placed into the solution bath, the washing region is sealed and heated to a suitable temperature for a predetermined period of time with stirring. This washing step is vigorous and results in substantially any remaining label portions and adhesive detaching from the HDPE flake.

The HDPE flake can then be removed from the solution bath, and sufficiently rinsed and dried. Rinsing of the HDPE flake can include further filtering or washing of the HDPE flake with water. Drying of the HDPE flake can be conducted under a controlled temperature for a predetermined amount of time. It will be appreciated that these steps may be performed in any other suitable manner known in the art.

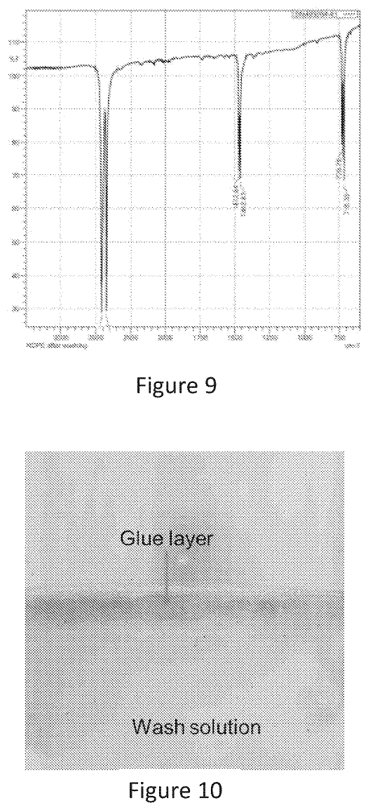

The end result of the process described above are HDPE flake that are now substantially free of any label portions or adhesives. This is best shown in FIGS. 8 and 9, which illustrate a clean HDPE surface substantially free of any of the label or adhesive. Thus, effectively pure HDPE flake can be used in a suitable HDPE recycling process to produce recycled HDPE that is free of contaminants and suitable for high grade applications, such as for food-grade applications.

In some embodiments, the washing solution is an aqueous solution comprising a surfactant and/or a polymeric dispersing agent, and a solvent. Further, if the laminate comprises a crosslinked glue, the solution may further comprise a base.

The solution may comprise any surfactant and/or polymeric dispersing agent that is able to solubilise the glue used to adhere the overlay to the substrate layer. In some embodiments, the solution comprises a surfactant. In other embodiments, the solution comprises a polymeric dispersing agent. In some embodiments, the solution comprises both a surfactant and a polymeric dispersing agent.

The surfactant may be an anionic, cationic or non-ionic surfactant, or a combination thereof. Blends of surfactants may include multiple surfactants of the same type, or combination of different classes of surfactant. Preferably, the surfactant is a low-foam surfactant, such as Teric BL9. A low foam surfactant reduces the foaming of the solution and therefore provides handling advantages in the processes of the invention.

Suitable non-ionic surfactants include ethoxylated alkanols, in particular ethoxylated fatty alcohols and ethoxylated oxoalcohols, such as ethoxylated lauryl alcohol, ethoxylated isotridecanol, ethoxylated cetyl alcohol, ethoxylated stearyl alcohol, and esters thereof, such as acetates; ethoxylated alkylphenols, such as ethoxylated nonylphenyl, ethoxylated dodecylphenyl, ethoxylated isotridecylphenol and the esters thereof, e.g. the acetates alkylglucosides and alkyl polyglucosides, ethoxylated alkylglucosides; ethoxylated fatty amines, ethoxylated fatty acids, partial esters, such as mono-, di- and triesters of fatty acids with glycerine or sorbitan, such as glycerine monostearate, glycerine monooleate, sorbitanmonolaurate, sorbitanmonopalmitate, sorbitanmonostearate, sorbitan monooleate, sorbitantristearate, sorbitan trioleate; ethoxylated esters of fatty acids with glycerine or sorbitan, such as polyoxyethylene glycerine monostearate, polyoxyethylene sorbitanmonolaurate, sorbitanmonopalmitate, polyoxyethylene sorbitanmonostearate, polyoxyethylene sorbitan monooleate, polyoxyethylene sorbitantristearate, polyoxyethylene sorbitan trioleate; ethoxylates of vegetable oils or animal fats, such as corn oil ethoxylate, castor oil ethoxylate, tallow oil ethoxylate; ethoxylates of fatty amines, fatty amides or of fatty acid diethanolamides.

Suitable anionic surfactants include salts, in particular, sodium, potassium calcium or ammonium salts of alkylsulfonates, such as lauryl sulfonate, isotridecylsulfonate, alkylsulfates, in particular fatty is alcohol sulfates, such as lauryl sulfate, isotridecylsulfate, cetylsulfate, stearylsulfate—aryl and alkylarylsulfonates, such as napthylsulfonate, dibutylnaphtylsulfonate, alkyldiphenylether sulfonates such as dodecyldiphenylether sulfonate, alkylbenzene sulfonates such as cumylsulfonate, nonylbenzenesulfonate and dodecylbenzene sulfonate; sulfonates of fatty acids and fatty acid esters;—sulfates of fatty acids and fatty acid esters; sulfates of ethoxylated alkanols, such as sulfates of ethoxylated lauryl alcohol; sulfates of alkoxylated alkylphenols; alkylphosphates and dialkylphosphates; dialkylesters of sulfosuccinic acid, such as dioctylsulfosuccinate, acylsarcosinates, fatty acids, such as stearates, acylglutamates, ligninsulfonates, low molecular weight condensates of naphthalinesulfonic acid or phenolsulfonic acid with formaldehyde and optionally urea.

Suitable cationic surfactants include quaternary ammonium compounds, in particular alkyltrimethylammonium salts and dialkyldimethylammonium salts, e.g. the halides, sulfates and alkylsulfates.

When present, the concentration of surfactant in the washing solution may vary depending on the material to be recycled, surfactant properties selected and depending on the other ingredients included. In some embodiments, the minimum concentration of the surfactant may be at least about 0.1 wt %, 0.5 wt %, 1 wt %, 2 wt %, 3 wt %, 4 wt % or 4.5 wt %. The maximum concentration of the surfactant may be up to about 30 wt %, 25 wt %, 20 wt %, 15 wt %, 10 wt %, 9 wt %, 8 wt %, 7 wt %, 6 wt % or 5 wt %. The washing solution may comprise the surfactant in a concentration from any of these minimum values to any of these maximum values, for example, from about 0.1 wt % to about 30 wt % or about 1 wt % to about 10 wt %.

The polymeric dispersing agent may be any agent capable of interacting with the glue and any contaminants to assist their removal from overlay and/or substrate layer. While most embodiments of suitable polymeric dispersing agents may also be considered surfactants, some embodiments of polymeric dispersing agent would not classically be within the surfactant class. Thus, in some embodiments, the polymeric dispersing agent may be a surfactant.

The polymeric dispersing agent may be non-ionic, anionic, cationic and/or zwitterionic. In some embodiments, the polymeric dispersing agent may comprise a hydrophobic group (such as Orotan series copolymers, e.g. a sodium salt of a maleic anhydride copolymer). Hydrophobic groups may improve interactions of the polymeric dispersing agent with any hydrophobic contaminants present in the overlay, glue and/or substrate layer. In some embodiments, the polymeric dispersing agent may include polymers/copolymers comprising a hydrophilic group capable of micellizing at elevated temperatures. Suitable examples include poly(NIPAM), or polymers/copolymers which can phase separate the glue into a removeable oil layer including copolymers of poly(ethylene oxide)/poly(propylene oxide) (Pluronic copolymers). In some embodiments, the polymeric dispersing agent comprises both a hydrophilic group and a hydrophobic group, and in these embodiments the polymeric dispersing agent may be any of the surfactants described herein capable of polymer dispersal in solution.

Anionic polymeric dispersing agents include charged polymers/copolymers of polyacids and polyacid copolymers such as poly(acrylic acid) salts, poly(methacrylic acid) salts, poly(styrene sulfonic acid) salts, poly(styrene-co-maleate) salts, poly(hydroxy ethyl (meth)acrylate phosphate) salts (Visiomer HEMA-P 70M), and poly(vinylphosphonate) salts. Any suitable salt form of these agents may be used, including any commercially available salt form. Cationic polymeric dispersing agents include polymers/copolymers of quaternized ammonium salts such as poly(diallyldimethylammonium chloride) (poly(DADMAC)) and its copolymers, poly(dimethylaminoethyl(meth)acrylate) and its copolymers, and poly(vinylpyrridine). Non-ionic polymeric dispersing agents include poly(vinyl alcohol), polyacrylamide, poly(N-isopropylacrylamide) (polyNIPAM), polyethylene glycol (polyethylene oxide), poly(propylene oxide), hydroxy functionalized poly(meth)acrylates (poly hydroxy ethyl acrylate, polyhydroxy ethyl methacrylate) and polyvinyl pyrrolidone. Zwitterionic polymeric dispersing agents include poly(sulfobetaine (meth)acrylate), poly(carboxybetaine (meth)acrylate), poly(phosphobetaine) such as poly(2-methacryloyloxyethyl phosphorylcholine), poly(2-acryloyloxyethyl phosphorylcholine) and copolymers of cationic and anionic monomers.

When present, the concentration of polymeric dispersing agent in the washing solution may vary depending on the material to be recycled, dispersing agent properties selected and depending on the other ingredients included. In some embodiments, the minimum concentration of the polymeric dispersing agent may be at least about 0.1 wt %, 0.5 wt %, 1 wt %, 2 wt %, 3 wt %, 4 wt % or 4.5 wt %. The maximum concentration of the polymeric dispersing agent may be up to about 30 wt %, 25 wt %, 20 wt %, 15 wt %, 10 wt %, 9 wt %, 8 wt %, 7 wt %, 6 wt % or 5 wt %. The washing solution may comprise the polymeric dispersing agent in a concentration from any of these minimum values to any of these maximum values, for example, from about 0.1 wt % to about 30 wt % or about 1 wt % to about 10 wt %.

In one embodiment, the surfactant and/or polymeric dispersing agent has/have a cloud point below the boiling point of the washing solution. The use of surfactants/polymer dispersing agent with cloud point below the boiling point of the washing solution may be advantageous to induce phase separation in the wash solution when heated to above a washing temperature (e.g. about 95° C.). The used washing solution may be heated while in contact with the laminate, or in a separate step after completion of the washing step in the methods described herein. After heating, washed glue may separate into a separate phase, typically a less dense phase floating at the surface of the used washing solution. Partitioning the glue into a separate phase forms a liquid layer that can be removed. Where a hydrophobic solvent is used, separating the hydrophobic layer may take place in a settling tower which may be connected to the reactor. Separating dissolved glue from the used washing solution, may allow the washing solution to be refurbished and reused (see, for example, Example 2A). The reusability of the washing solution is advantageous for cost and environmental reasons.

The washing solution comprises a solvent, which may be any non-aqueous solvent (or combination thereof) that is capable of solubilising the adhesive and assisting in the separation of the substrate layer and overlay.

The solvent is also preferably food safe. Food safe solvents are preferred to minimise the risk of contamination in recycled materials for preparing food packaging. However, even in such processes, a solvent may be used in the process that is not food safe provided it is substantially removed (eg at least to below food safe levels) prior to the recycled material contacting food. Further, depending on the desired use of the recycled material, the process need not produce food safe recycled materials.

Suitable solvents for this process can include dimethyl sulfoxide, N-methylpyrrolidone, dimethyl acetamide, N,N-dimethylformamide, propylene carbonate, acetonitrile, 2-methoxyethanol, pyridine, ethylene glycol, ethanol, methanol, acetone, 1,4-dioxane, methyl ethyl ketone, ethyl acetate, chloroform, tetrahydrofuran, dimethoxyethane, n-propyl alcohol, n-butyl acetate, isopropyl alcohol, 1,2-dichloroethane, dichloromethane, diethyl ether, o-dichlorobenzene, o-xylene, toluene, cyclohexane, hexane, heptane, cyclopentane, pentane, benzyl alcohol, 1,3-butylene glycol, an edible oil (eg castor oil), mono- and di-glycerides and/or esters thereof, glycerol, glyceryl alkylate (eg glyceryl mono- di- or triacetate, mono-, di-, or tri-butyrate), hexane, isopropyl alcohol, 1,2-propylene glycol, propylene glycol mono-esters and diesters of fat-forming fatty acids, triethyl citrate or mixtures thereof. Suitable solvents are also described in Industrial Solvents Handbook, 5th Ed. by Ernest W. Flick, 9780815514138, Westwood, N.J.: Noyes Data Corp., 1998, which is hereby entirely incorporated by reference.

Suitable food safe solvents include dimethyl sulfoxide, propylene carbonate, acetone, benzyl alcohol, 1,3-butylene glycol, an edible oil (eg castor oil), mono- and di-glycerides and/or esters thereof, ethyl acetate, ethanol, glycerol, glyceryl alkylate (eg glyceryl mono- di- or triacetate, mono-, di-, or tri-butyrate), hexane, isopropyl alcohol, methanol, methyl ethyl ketone, dichloromethane, 1,2-propylene glycol, propylene glycol mono-esters and diesters of fat-forming fatty acids, triethyl citrate and combinations thereof.

In some embodiments, the solvent is propylene carbonate optionally in combination with one or more further solvents, for example selected from the above list.

The concentration of solvent in the washing solution may vary depending on the material to be recycled, solvent properties and depending on the other ingredients included. There is no particular limit on the amount of solvent that can be used in the washing solution, except that allowance needs to be made for the amount of surfactant that is included. In general, the amount of solvent used will be governed by cost and safety. As a broad generality, the more solvent present the quicker the washing operation and the lower the temperature required. Thus, there is a balance between ease of washing and low heating time and cost, against cost of solvent and cost of solvent disposal. In some embodiments, the minimum concentration of the solvent may be at least about 0.1 wt %, 0.5 wt %, 1 wt %, 1.5 wt %. 2 wt %, 2.5 wt %, 3 wt %, 3.5 wt % or 4 wt %. The maximum concentration of the solvent may be up to about 30 wt %, 25 wt %, 20 wt %, 15 wt %, 10 wt %, 9 wt %, 8 wt %, 7 wt %, 6 wt %, 5 wt % or 4.5 wt %. The washing solution may comprise the solvent in a concentration from any of these minimum values to any of these maximum values, for example, from about 0.1 wt % to about 30 wt % or about 1 wt % to about 15 wt %.

In some embodiments, the solution comprises a base. The base is typically suitable to hydrolyse ester/acid functional groups on contaminants or within the glue adhering the one or more layers of the overlay to the substrate layer. The base may also assist in breaking any cross-linking formed within the glue. Hydrolysed contaminants and degraded glue tend to be more hydrophilic so more readily removed in the washing step. Typically, the base is a strong base; however, in some embodiments the base may comprise a mixture of a strong base and one or more weak bases. In some embodiments, the base is selected from a hydroxide (eg sodium hydroxide, potassium hydroxide, ammonium hydroxide, and so on including combinations thereof), an alkoxide (eg a sodium or potassium salt of methoxide, ethoxide, iso-propoxide and so on including combinations thereof) or a combination thereof. In some embodiments, the base is sodium hydroxide.

The concentration of base in the washing solution may vary depending on the material to be recycled, base properties and depending on the other ingredients included. In some embodiments, the minimum concentration of the base may be at least about 0.1 wt %, 0.5 wt %, 1 wt %, 1.5 wt % or 2 wt %. The maximum concentration of the surfactant may be up to about 10 wt %, 9 wt %, 8 wt %, 7 wt %, 6 wt %, 5 wt %, 4 wt %, or 3 wt %. The washing solution may comprise the surfactant in a concentration from any of these minimum values to any of these maximum values, for example, from about 0.1 wt % to about 10 wt % or about 0.5 wt % to about 5 wt %.

In some embodiments, the molarity of the base may be at least about 0.1M, 0.2M, 0.3M, 0.4M, 0.5M, 0.6M, 0.7M, 0.8M, 0.9M, 1M, 2M, 3M, 4M, 5M, 6M, 7M, 8M, 9M, 10M or greater. The molarity of the base in the washing solution may be from any of these values to any other value, for example, from about 0.1M to about 10M or about 0.5M to about 0.8M.

The balance of the washing solution will typically be water. In some embodiments, the washing solution comprises water in a minimum concentration of at least about 40 wt %, 45 wt %, 50 wt %, 55 wt %, 60 wt %, 65 wt %, 70 wt %, 75 wt %, 80 wt %, 85 wt % or 89 wt %. The washing solution may comprise water in a maximum concentration of up to about 99.7 wt %, 99 wt %, 95 wt %, or 90 wt %. The concentration of water may be from any of these minimum amounts to any of these maximum amounts, for example, from about 50 wt % to about 99.7 wt % or about 75 wt % to about 95 wt %.

Whilst the embodiment described above involves a recycling process that includes both an impact delamination step and a washing step in order to produce satisfactory removal of an overlay and adhesive from an underlying substrate, it will be appreciated that the use of either one of these steps in existing recycling processes can improve the end result of those processes.

It will be understood that the invention disclosed and defined in this specification extends to all alternative combinations of two or more of the individual features mentioned or evident from the text or drawings. All of these different combinations constitute various alternative aspects of the invention.

### EXAMPLES

The invention will be further described by way of non-limiting example(s). It will be understood to persons skilled in the art of the invention that many modifications may be made without departing from the spirit and scope of the invention.

### Example 1a. Impact Delamination of HDPE Milk Bottle Labels

Labelled high density polyethylene (HDPE) pieces (8 cm×10 cm) were removed from empty 2 L (Country Valley brand) milk bottles. They were washed and dried then cut into two (4 cm×10 cm) sections using scissors. Six (6) such sections were loaded into the 500 mL cup of a blender (NutriBullet 1000 series) equipped with 6 blunt extractor blades. The blender was run for approximately 30 seconds (25,000 rpm) to produce a mix of mostly clean, label free HDPE flake (approximately between 0.25-4 cm²) and delaminated fluffy labels. However, a small amount of flake still had the label fragments attached while adhesive from the milk bottle label was observed to build up on the cup interior. After blending, more compact HDPE flake (both clean or label attached) were separated from the light and fluffy delaminated labels by air blowing. FTIR showed that most of the label free HDPE flake was substantially free of adhesive (see FIGS. 3, 4, 5 and 7).

### Example 1b. Chemical Washing of Mechanically Delaminated HDPE Flake

A solution was prepared by dissolving the alcohol alcoholate non-ionic surfactant Teric BL9 (12.5 g) and sodium hydroxide (6.0 g) in water (250.0 g) and dimethylsulfoxide (DMSO, 12.0 g) in a glass jar. To this solution, HDPE flake (30.0 g) from Example 1a was added. The jar was sealed and heated at 95° C. for 30 minutes under magnetic stirring. After heating, the remaining labels were observed to detach from the HDPE flake. Flake were filtered, washed with cold water then dried in an oven overnight at 50° C. After drying, the HDPE flake was separated from the light and fluffy labels by air blowing. FTIR showed that the washed HDPE flake was free of label adhesive.

### Example 2a. Chemical Washing of Mechanically Delaminated HDPE Flake Using Propylene Carbonate as Solvent

A solution was prepared by dissolving Teric BL9 surfactant (12.5 g) and sodium hydroxide (6.0 g) in water (250.0 g) and propylene carbonate (PC, 12.0 g) in a glass jar. To this solution, HDPE flake (30.0 g) from Example 1, a) was added. The jar was sealed and heated at 95° C. for 30 minutes under magnetic stirring. After heating, the remaining labels were observed to detach from the HDPE flake. Flake was filtered, washed with cold water then dried in an oven overnight at 50° C. After drying, the HDPE flake was separated from the light and fluffy labels by air blowing.

The used washing solution was then heated to 95° C., whereupon it phase separated into a dirty dark green oily top layer (containing glue and other contaminants) and slightly cloudy bottom layer (wash solution) as shown in FIG. 10. The oily layer was carefully removed using a separating funnel and the remaining solution was kept for future use in sample washing.

### Example 2b. Chemical Washing of Mechanically Delaminated HDPE Flake Using Propylene Carbonate as Solvent

The chemical solution from example 2a was re-used to wash 30 g dirty HDPE milk bottle flake (Pegras) using the same process. After washing, filtering and drying, the labels were found to be separated from the flake. They were removed from washed HDPE flake by air blowing.

### Example 3. Chemical Washing of Mechanically Delaminated HDPE Flake Using Propylene Carbonate as Solvent and Disponil FES993 (Fatty Alcohol Polyglycol Ether Sulphate Sodium Salt, BASF) as a Surfactant

Same procedure as in Example 2a was used with Disponil FES993 as surfactant. The labels were found to be effectively removed from the HDPE flake.

### Example 4. Chemical Washing of Mechanically Delaminated HDPE Flake Using Propylene Carbonate as Solvent and Aerosol MA80-I (Sodium Dihexyl Sulfosuccinate, Solvay) as a Surfactant

Same procedure as in Example 2a was used with Aerosol MA80-I as surfactant. The labels were found to be effectively removed from HDPE flake.

### Example 5. Chemical Washing of Mechanically Delaminated HDPE Flake Using Toluene as a Solvent

Same procedure as in Example 1 b was used with Toluene as solvent and wash temperature was at 70° C. The labels were found to be effectively removed from HDPE flake.

### Example 6. Impact Delamination of HDPE Milk Bottle Labels in Water (Wet Process)

Same procedure as in Example 1a was used in water (30 g) to produce visually clean delaminated HDPE flake and separated labels with glue attached. FTIR showed that most of the label free HDPE flake was substantially free of adhesive.

### Example 7. Impact Delamination of Labelled Polypropylene (PP) Waste

Same procedure as in Example 1a was used with 20 g of PP pieces with attached labels (Ice cream container, Streets) to produce delaminated PP flake and separated labels with glue attached.

### Example 8. Impact Delamination of Labelled Polyethylene Terephthalate (PET) Waste

Same procedure as in Example 1a was used with 23 g of PET pieces with attached labels (1.25 L Lemonade drink bottle, Schweppes) to produce delaminated PET flake and separated labels with glue attached.

### Example 9. Impact Delamination of Labelled Coloured HDPE Waste

Same procedure as in Example 1a was used with 22 g of coloured HDPE pieces with attached labels (shower gel bottle, Palmolive) to produce delaminated coloured HDPE flake and separated labels with glue attached.

### Example 10. Chemical Washing of Mechanically Delaminated PET Flake Using Poly(Ethylene Oxide) (PEO)

A solution was prepared by dissolving PEO (0.5 g, 100K g/mole) and sodium hydroxide (2.4 g) in water (99.5 g) and dimethylsulfoxide (DMSO, 5.0 g) in a glass jar. To this solution, PET flake (10.0 g) from Example 8 was added. The jar was sealed and heated at 90° C. for 30 minutes under magnetic stirring. After heating, the remaining labels were observed to detach from the PET flake. The flake was filtered, washed with cold water then dried in an oven overnight at 50° C. After drying, the PET flake was separated from the light and fluffy labels by air blowing. The washed flake was visually found to be free of label adhesive.

### Example 11. Chemical Washing of Mechanically Delaminated HDPE Flake Using Pluronic F68 Poly Ethylene Oxide/Polypropylene Oxide Copolymer

Impact delaminated HDPE flake was prepared in the same manner as in Example 1a but with a whole 2 L milk bottle (Country Valley brand) (about 45 g). After removal of detached labels, the HDPE flake was used for further chemical washing. A solution was prepared by dissolving Pluronic F68 (BASF) (0.5 g) and sodium hydroxide (2.4 g) in water (99.5 g) and dimethylsulfoxide (DMSO, 5.0 g) in a glass jar. This solution was used to wash the above flake (10 g) in the same procedure described in Example 10. After washing, the sample of flake was visibly clean.

### Example 12. Chemical Washing of Mechanically Delaminated HDPE Flake Using Negatively Charged Orotan 731A Maleic Anhydride Copolymers

A solution was prepared by dissolving Orotan 731A solution (Dow) (1.0 g) and sodium hydroxide (2.4 g) in water (99.0 g) and dimethylsulfoxide (DMSO, 5.0 g) in a glass jar. This solution was used to wash the above HDPE flake from Example 11a (10 g) in the same procedure described in Example 10. After washing, the sample of flake was visibly clean.

### Example 13. Chemical Washing of Mechanically Delaminated HDPE Flake Using Positively Charged Poly(acrylamide-co-diallyldimethyl Ammonium Chloride) (Poly(AAm-co-DADMAC))

A solution was prepared by mixing poly(AAm-co-DADMAC) solution (Sigma Aldrich) (10 g) and sodium hydroxide (2.4 g) in water (90.0 g) and dimethylsulfoxide (DMSO, 5.0 g) in a glass jar. This solution was used to wash the above HDPE flake from Example 11a (10 g) in the same procedure described in Example 10. After washing, the sample of flake was visibly clean.

1. A process for recycling a laminate that includes a substrate layer and an overlay adhered to the substrate layer with a glue, the overlay including one or more surface layers, the process including:
subjecting the laminate to an impact frictional striking force, thereby substantially separating the substrate layer from the one or more surface layers of the overlay; and then
washing the substrate layer with a washing solution to remove the remaining surface layers of the overlay and glue from the substrate layer.

2. The process of claim 1, wherein the subjecting step is conducted in substantially dry conditions.

3. The process of claim 1, wherein the subjecting step is conducted in wet conditions.

4. The process of claim 3, wherein the subjecting step is conducted in the presence of water.

5. The process of claim 3 or claim 4, wherein the subjecting step is followed by drying a mixture of the substrate and the one or more surface layers of the overlay.

6. The process of any one of the preceding claims, wherein the impact frictional striking force is imparted on the laminate by one or more impactors, wherein the one or more impactors have a relatively blunt leading edge.

7. The process of claim 6, wherein the impact frictional striking force is controlled by adjusting one or more of the following operational parameters: rotational speed of the impactors, peripheral speed of the impactors, force, strain, temperature and pressure.

8. The process of any one of the preceding claims, further including, after the subjecting step but before the washing step, segregating a mixture of the separated substrate layer and one or more surface layers of the overlay.

9. The process of claim 8, wherein the segregating step includes removing the one or more layers of the overlay by applying suction or blowing to the mixture.

10. The process of any one of the preceding claims, further including drying the washed substrate layer.

11. The process of any one of the preceding claims, wherein the substrate layer includes a high-density polyethylene (HDPE) material.

12. The process of any one of the preceding claims, wherein the one or more surfaces of the overlay together form a label.

13. The process of any one of the preceding claims, wherein the washing solution is an aqueous solution comprising a surfactant and/or polymeric dispersing agent, and a solvent.

14. The process of claim 13, wherein the washing solution comprises a base.

15. The process of any one of the preceding claims, wherein the subjecting step also fragments the laminate.

16. A process for recycling a laminate that includes a substrate layer and an overlay adhered to the substrate layer with a glue, the overlay including one or more surface layers, the process including:
washing the substrate layer with a solution to remove the one or more surface layers of the overlay from the substrate layer and the glue, the solution including a surfactant and/or a polymeric dispersing agent, and a solvent.

17. The process of claim 15, further including subjecting the laminate to an impact frictional striking force, thereby substantially separating the substrate layer from the one or more surface layers of the overlay.

18. A process for recycling a laminate that includes a substrate layer and an overlay adhered to the substrate layer with a glue, the overlay including one or more surface layers, the process including:
subjecting the laminate to an impact frictional striking force, thereby substantially separating the substrate layer from the one or more surfaces of the overlay, wherein the subjecting step also fragments the laminate.

19. The process of claim 18, further including washing the substrate layer with a solution to remove the one or more surface layers of the overlay from the substrate layer and the glue, the solution including a surfactant and/or a polymeric dispersing agent, and a solvent.

20. Use of a solution comprising a surfactant and/or a polymeric dispersing agent, and a base for removing a glue from a laminate comprising a substrate and an overlay adhered to the substrate with the glue, the overlay comprising one or more surface layers.

21. A recycling process including:
washing a laminate, which includes a substrate layer adhered to an overlay including one or more surface layers, with a washing solution to remove one or more surface layers of the overlay from the substrate layer, the washing solution comprising a surfactant and/or polymeric dispersing agent, a solvent and optionally a base, wherein the surfactant and/or polymeric dispersing agent has/have a cloud point that is below a boiling point of the washing solution; and
heating the washing solution to above the cloud point of the surfactant and/or polymeric dispersing agent.
